(19) United States
(12) Patent Application Publication
(10) Pub. No.: US 2010/0274002 A1
(43) Pub. Date: Oct. 28, 2010

(54) CYCLODEXTRIN-SILANE COMPLEXES

(75) Inventors: Manfred Amann, Odelzhausen (DE); Wolfgang Hecht, Munich (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/808,067

(22) PCT Filed: Dec. 5, 2008
(86) PCT No.: PCT/EP08/66862

§ 371 Date: Jun. 14, 2010

(30) Foreign Application Priority Data
Dec. 12, 2007 (DE) 102007055776.2

(51) Int. Cl. C08B 37/16

(52) U.S. Cl. 536/103

(57) ABSTRACT

Complexes of silanes and cyclodextrin or derivatives thereof are storage stable and allow target release of silane or decomposition products thereof.

The invention relates to cyclodextrin/silane complexes, to their preparation and their use.

Silanes are used in many ways for functionalizing surfaces (“silanization”), be the molecular surfaces of small molecules or the surfaces of nano-scale or micro-scale structures, or macroscopic surfaces. Depending on the structure, the silanes have different chemical stability and different reactivity qualities, which must be taken into consideration when using silanes. Thus, for example, halogenated or alkoxylated silanes hydrolyze in the presence of water. The silanes' instability limits their usability. Likewise, the silanes' physical properties limit their possible uses. Silanes are usually present in liquid form; frequently, they are volatile even at room temperature. The necessity of processing silanes as liquids limits their usability in many technical applications. It is therefore an important object to develop processes for stabilizing silanes.

Cyclodextrins (CDs) are cyclic nonreducing oligosaccharides which are composed of glucose units. Their outer surface is hydrophilic, by virtue of which fact they are soluble in water. Their inner surface is hydrophobic in character. This is why CDs are capable of forming inclusion compounds with smaller molecules.

Cyclodextrin complexes with silicon-containing compounds are described by various authors. These papers deal with cyclodextrin/polymer interactions or with interactions of cyclodextrins with low-molecular-weight siloxanes, but not with cyclodextrin/silane interactions.

Thus, Okumura et al. (2001, Makromolecules 34, 6338-43) describe the threading of cyclodextrin onto polydimethylsiloxanes. Wenz et al. quite generally describe (Chem. Review 2006, 106, 782-817) the cyclodextrin/polymer interactions (rotaxanes and polyrotaxanes). The technical use of such complexes is described in WO 9631540.

Felix, K. et al. (1996) Curr. Top. Microbiol. Immunol. 210 (Immunology of Silicones), 93-9) describe membrane interactions of gamma-CD complexes with octamethylcyclotetrasiloxane and other small stable siloxanes.

The object of the invention is to provide silanes in such a way that their technical applicability is enhanced.

The object is solved by a complex of a cyclodextrin or cyclodextrin derivative and a silane.

The silanes which, as a rule, are liquid at room temperature (20° C.) and standard pressure are stabilized in the complex according to the invention and provided as a pulverulent solid. This powder formulation markedly improves the technical applicability of the silanes. Being in powder form, the silane complexes can be processed and stored without problems.

For the purposes of the present invention, silanes are preferably low-molecular-weight silicon compounds of the general formula (I)

YₑSiR¹(4−e) (I)

where
Y represents hydrogen, an OH group, halogen, an OR¹ group,
R¹ represents an optionally hetero-atom-substituted aliphatic or aromatic hydrocarbon radical having 1-12 carbon atoms and
e can assume the values 1, 2, 3 and 4,
which compounds are liquid at 20° C. and standard pressure.

The silane preferably takes the form of a silane which is susceptible to hydrolysis. It especially preferably takes the form of an alkoxysilane, for example an isooctyltriethoxysilane, a tetraethoxysilane, a tetraisopropoxysilane or a tetra-n-propoxysilane.

The cyclodextrins or cyclodextrin derivative take the form of any cyclodextrin or cyclodextrin derivative or a mixture of at least two different types of such cyclodextrins or cyclodextrin derivatives.

Preferably, they take the form of a cyclodextrin or cyclodextrin derivative of the formula II

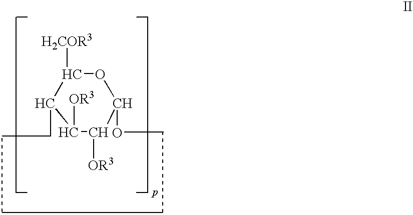

where R³ can be identical or different and represents hydrogen or an optionally hetero-atom-substituted aliphatic or aromatic hydrocarbon radical having 1-12 carbon atoms and p is an integer from 6 to 120.

Examples of R³ are hydrogen atom, alkyl radical having 1 to 10 carbon atoms, acyl radicals having 1 to 10 carbon atoms, glycosyl radical, cationically and anionically charged radical.

R³ preferably takes the form of hydrogen atom, methyl, hydroxypropyl, acetyl, carboxymethyl or 2-OH-3-trimethylammoniopropyl radical, with methyl and hydroxypropyl radicals being especially preferred.

If all R³ represent hydrogen, the compounds of the formula (II) take the form of native unmodified cyclodextrins. Cyclodextrins are outwardly hydrophilic, by virtue of which fact they dissolve very readily in water.

If at least one R³ has a meaning other than hydrogen, the compounds of the formula (II) take the form of cyclodextrin derivatives. The number and type of derivatized positions in the cyclodextrin determines inter alia the hydrophilic behavior of the cyclodextrin derivatives.

Preferably, p is 6, 7 or 8, especially preferably 8.

Especially preferably, the cyclodextrin in the complex according to the invention therefore takes the form of a gamma-cyclodextrin or a derivative of gamma-cyclodextrin.

The cyclodextrins or cyclodextrin derivatives are commercially available products or can be prepared by processes conventionally used in chemistry or biotechnology. Native cyclodextrins (alpha-, beta- and gamma-CD) and derivatized cyclodextrins (for example methylated, hydroxypropylated) can be obtained for example from Wacker Chemie AG.

The invention furthermore relates to the preparation of the complexes according to the invention.

The complexes are prepared by bringing the silane to be complexed and the cyclodextrin into contact with each other over a period of from 1 min to 24 hours, preferably from 0.5 to 5 h, especially preferably 1 h, and subsequently immediately separating the complex formed from any solvent which may be present.

In the process according to the invention, cyclodextrins or cyclodextrin derivatives and silanes are preferably employed in a molar ratio of from 10:1 to 1:10, especially preferably 3:1 to 1:3, particularly preferably 1:1.

In the process according to the invention, the bringing-into-contact of the two starting materials can be effected as desired. Here, the cyclodextrins or cyclodextrin derivatives and the silanes are brought into contact as intimately as possible, for example by vigorous stirring, shaking or kneading.

The bringing-into-contact is preferably carried out over a period of from 1 min to 24 hours, preferably from 0.5 to 5 h, especially preferably 1 h.

If desired, it is possible to employ solvents in addition to cyclodextrin (derivative) and silane, where the term solvent does not mean that all reactants have to be soluble in the former. Thus, it is possible to use solvents in which both cyclodextrin (derivative) and silane dissolve fully or partially, or else solvents in which exclusively the cyclodextrin (derivative) or the silane dissolves fully or partially.

The solvent which is optionally employed preferably takes the form of water, polar organic solvents such as alcohols (for example methanol, ethanol, propanol, isopropanol and butanol), acetone, tetrahydrofuran or dimethyl sulfoxide, apolar organic solvents such as acetonitrile, chloroform, diethyl ether, ethyl acetate, p-xylene and alkanes, and their mixtures.

The solvent which is optionally employed preferably takes the form of water.

It is essential to the process according to the invention that, if a solvent is present, it is removed from the complex formed immediately after forming the complex by means of bringing-into-contact.

In the process according to the invention, the temperature can be varied over a wide range and depends essentially only on the stability of the silane and the cyclodextrin (derivative) used. The process according to the invention is carried out at a temperature of preferably from 5 to 95° C., especially preferably from 30 to 70° C., and preferably at ambient pressure, i.e. a pressure between 900 and 1100 hPa.

If the process according to the invention is carried out in the presence of solvent, in particular water, cyclodextrin/silane complexes according to the invention are therefore obtained which, depending on the nature of the silane and of the cyclodextrin (derivative), are dissolved fully or partially in the solvent used. The cyclodextrin/silane complexes according to the invention can be isolated by removing the solvent, for example by temperature treatment, distillation, evaporation on a rotary evaporator, spray-drying or lyophilization.

The process according to the invention has the advantage that the cyclodextrin/silane complexes according to the invention are obtained in a simple manner.

The invention furthermore relates to the use of the complexes according to the invention.

The complex according to the invention is suitable for various applications, for example for cooling, which can be achieved by evaporating ethanol.

A further use of such complexes is to provide substrates for enzymes which are capable of utilizing for example ethanol as their substrate, such as, for example, alcohol-specific oxidases or dehydrogenases. The effect of alcohol oxidases may lead to the formation of hydrogen peroxide which, if appropriate, can exhibit its desired activity for example as a further enzyme substrate or as a bleaching chemical. This can be exploited advantageously for developing test methods.

The complex is furthermore suitable as a store for the targeted release of unstable components of the complexed silane. Thus, for example, tetraethoxysilane is a storage compound for four molecules of ethanol. Complexes of a silane and a cyclodextrin can thus be used for the controlled release of the silane residues, for example as a slow-release preparation of hydrolysable groups of silanes (ethanol, methanol, isopropanol). Thus, it is possible to exploit the biocidal activity of ethanol, isopropanol and n-propanol upon access of moisture to the respective cyclodextrin complexes of tetraethoxysilane, tetra-isopropoxysilane or tetra-n-propoxysilane. Another possibility is the advantageous use of the silica released upon hydrolysis, which is required for example at a low concentration when synthesizing silica-based nanostructures.

When using the complexes according to the invention for the targeted release of unstable components of the complexed silane, only environmentally friendly toxicologically acceptable products (cyclodextrins, silica, alcohol) result.

Complexes of CD and hydrophobic silanes (for example isooctyltriethoxysilane) are suitable for example for hydrophobicizing dry mortars.

The examples which follow are intended to further illustrate the invention:

### EXAMPLE 1

### Preparation of a Complex of Gamma-Cyclodextrin and Tetraethoxysilane

8.0 g of tetraethoxysilane (TES 28 Wacker Chemie AG; 39 mmol) were metered into a cyclodextrin-containing solution of 450 ml of water and 50 g of gamma-cyclodextrin (Wacker Chemie AG; 39 mmol). In a horizontal shaker, the solutions, which are immiscible, were brought into intimate contact at room temperature, as a result of which a white precipitate formed. The precipitate was separated off immediately (filtration or centrifugation), washed with water and dried in a drying oven at 80° C. The resulting powder was stable at room temperature when stored under dry conditions.

### EXAMPLE 2

### Analysis of the Cyclodextrin/Tetraethoxysilane Complex

The composition of the complex of example 1 was determined after having been dissolved in dimethyl sulfoxide (DMSO)-d6 by integrating the signals of the ethyl group (TES) and of cyclodextrin using ¹H-NMR. Here, it was demonstrated that tetraethoxysilane and gamma-cyclodextrin formed a stoichiometric 1:1 complex.

The complexes were thermally stable. While free tetraethoxysilane started to volatilize even when raising the temperature slightly and was destroyed completely at approximately 160° C., thermal analysis demonstrated that the TES/gamma-cyclodextrin complex was stable up to approx. 250° C. and disintegrated together with the cyclodextrin from approx. 280° C.

### EXAMPLE 3

### Preparation and Analysis of a Complex of Gamma-Cyclodextrin and Tetraisopropoxysilane

6.6 g of tetra-iso-propoxysilane (Gelest, ABCR) were metered into a cyclodextrin-containing solution of 400 ml of water and 80 g of gamma-cyclodextrin (Wacker Chemie AG). In a horizontal shaker, the solutions, which are immiscible, were brought into intimate contact at room temperature, as a result of which a white precipitate formed. The precipitate was separated off immediately (filtration or centrifugation), washed with water and dried in a drying oven at 80° C. The powder, which had been obtained in 97% yield, was stable at room temperature when stored under dry conditions. The stoichiometry of the complex (gamma-CD:silane) was 2:1 (¹H-NMR). The thermal stability corresponded to the complexes with TEOS (example 1).

### EXAMPLE 4

### Preparation and Analysis of a Complex of Cyclodextrin and Tetra-n-Propoxysilane

13.2 g of tetra-n-propoxysilane (Gelest, ABCR) were metered into a cyclodextrin-containing solution of 400 ml of water and 80 g of gamma-cyclodextrin (Wacker Chemie AG). In a horizontal shaker, the solutions, which are immiscible, were brought into intimate contact at room temperature, as a result of which a white precipitate formed. The precipitate was separated off immediately (filtration or centrifugation), washed with water and dried in a drying oven at 80° C. The powder, which had been obtained in 91% yield, was stable at room temperature when stored under dry conditions. The stoichiometry of the complex was 1:1 (¹H-NMR). The thermal stability corresponded to the complexes with TEOS (example 1).

### EXAMPLE 5

### Release of Alcohols from Gamma-Cyclodextrin/Alkoxysilane Complexes

When the pulverulent complexes prepared in examples 1, 3 and 4 are exposed to hydrolytic conditions (moisture, access of water), then the alkoxysilane, which is bound in the complex, can slowly release the bound alcohols. The end products of this reaction are SiO₂ and the corresponding alcohols.

It was possible to monitor the hydrolysis by means of ¹H-NMR in D₂O since alcohols which are present in free form (ethanol, n-propanol, iso-propanol) and silane-bound alcohol residues showed clearly separated signals in the ¹H-NMR.

### EXAMPLE 6

### Use of Gamma-Cyclodextrin/Alkoxysilane Complexes as Biocide

Alcohols such as ethanol, n-propanol or iso-propanol are effective and widely used compounds for destroying or controlling undesired microorganisms. Cyclodextrin/alkoxysilane complexes are capable of releasing alcohol. Gamma-cyclodextrin/alkoxysilane complexes can therefore be considered to be a pulverulent formulation of the alcohols in question. Upon contact with moisture, the alcohol can be released and can demonstrate its biocidal activity.

The experiments were carried out in suspension using different microorganisms (bacteria, fungi):

| | |
|---|---|
| Staphylococcus (S.) epidermidis | ATCC 12228 |
| Micrococcus (M.) sedentarius | DSM 20317 |
| Trichophyton (T.) rubrum | ATCC 28189 |

The tests were carried out following the DGHM (Deutsche Gesellschaft für Hygiene and Mikrobiologie [German Society for Hygiene and Microbiology]) guidelines; the parameter assessed was the microbial growth (the media are as specified by the ATCC or the DSM) after an exposure time of 3 days. The test concentration was 30%. The microorganisms were grown at 37° C.

The growth of the organisms was assessed with reference to the turbidity of the medium. In all cases where turbidity (or growth) was observed, subcultures were established for reidentifying the test microorganisms used in each case by differential methods conventionally used in laboratories.

The results of the tests for the three silane complexes (gamma-CD with tetraethoxy—TEOS, tetra-n-propoxy—T-n-Pr and tetraisopropoxy—T-iso-Pr are compiled in the table.

+ means: growth in the presence of the hydrolyzing silane complex
− means: no growth in the presence of the hydrolyzing silane complex

| | TEOS | T-n-Pr | T-iso-Pr |
|---|---|---|---|
| Staphylococcus (S.) epidermidis | − | − | + |
| ATCC 12228 | | | |
| Micrococcus (M.) sedentarius | + | − | + |
| DSM 20317 | | | |
| Trichophyton (T.) rubrum | + | + | − |
| ATCC 28189 | | | |

Upon contact with water, the gamma-cyclodextrin/alkoxysilane complexes are capable of inhibiting the growth of various microorganisms.

1.-10. (canceled)

11. A complex of a cyclodextrin or cyclodextrin derivative and a silane.

12. The complex of claim 11, wherein the silane is a low-molecular-weight silicon compound of the formula (I)
YₑSiR¹₍₄₋ₑ₎ (I)
where
Y is hydrogen, an OH group, halogen, or an OR¹ group,
R¹ is an optionally hetero-atom-substituted aliphatic or aromatic hydrocarbon radical having 1-12 carbon atoms and
e is 1, 2, 3 and 4,
and wherein the silicon compound is liquid at 20° C. and standard pressure.

13. The complex of claim 11, wherein the silane is susceptible to hydrolysis.

14. The complex of claim 11, wherein the silane is an alkoxysilane.

15. The complex of claim 11, wherein the cyclodextrin or cyclodextrin derivative is a compound of the formula (II) 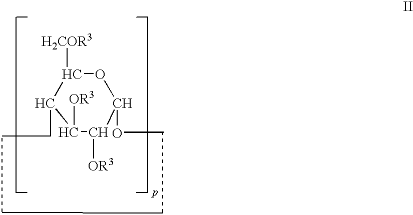
where each R³ is identical or different and is hydrogen or an optionally hetero-atom-substituted aliphatic or aromatic hydrocarbon radical having 1-12 carbon atoms and p is an integer from 6 to 120.

16. The complex of claim 11, wherein the cyclodextrin or cyclodextrin derivative is gamma-cyclodextrin or a derivative of gamma-cyclodextrin.

17. A process for the preparation of a complex of claim 11, wherein the silane and the cyclodextrin or cyclodextrin derivative are contacted with each other over a period of from 1 min to 24 h and a complex formed therefrom is subsequently separated from any solvent which may be present.

18. The process of claim 17, wherein cyclodextrins or cyclodextrin derivatives and silanes are employed in a molar ratio of from 10:1 to 1:10.

19. The process of claim 17, wherein cyclodextrins or cyclodextrin derivatives and silanes are employed in a molar ratio with the range of 3:1 to 1:3.

20. The process of claim 17, wherein cyclodextrins or cyclodextrin derivatives and silanes are employed in a molar ratio with the range of about 1:1.

21. The process of claim 17, wherein a solvent selected from the group consisting of water, alcohol, acetone, tetrahydrofuran, dimethyl sulfoxide, acetonitrile, chloroform, diethyl ether, ethyl acetate, p-xylene, alkanes and their mixtures is present during contacting.

22. A process for the targeted release of silanes or unstable components of a complexed silane, comprising allowing a complex of silane and cyclodextrin or cyclodextrin derivatives of claim 11 to decompose.
